(19) United States
(12) Patent Application Publication
(10) Pub. No.: US 2026/0186157 A1
(43) Pub. Date: Jul. 2, 2026

(54) UNDERWATER ACOUSTIC SIGNAL DETECTION METHOD FOR DETECTING CETACEAN WHISTLE SIGNAL AND APPARATUS THEREFOR

(71) Applicant: AGENCY FOR DEFENSE DEVELOPMENT, Daejeon (KR)

(72) Inventors: Geun Ho PARK, Daejeon (KR); Jong Min AN, Daejeon (KR); Wan Jin KIM, Daejeon (KR); In Soo KIM, Daejeon (KR); Dong Hun LEE, Daejeon (KR); Hyung Moon KIM, Daejeon (KR); Sang Kuk LEE, Daejeon (KR)

(21) Appl. No.: 19/073,508

(22) Filed: Mar. 7, 2025

(30) Foreign Application Priority Data
Dec. 27, 2024 (KR) 10-2024-0198984

(51) Int. Cl. G01V 1/00

(52) U.S. Cl. CPC G01V 1/001; G01V 2210/1423; G01V 2210/21; G01V 2210/38

(57) ABSTRACT

Provided is an underwater acoustic signal detection method performed by an electronic apparatus, including identifying, based on acoustic data obtained from an acoustic signal received underwater, a target frequency value measured at a reference point in a time-frequency domain of the acoustic data, determining whether the target frequency value is associated with tracking data related to tracking of a target detection acoustic signal included in the acoustic signal, and updating the tracking data based on the association of the target frequency value with the tracking data.

### PRIORITY INFORMATION

This application claims the benefit of Korean Patent Application No. 10-2024-0198984, filed on Dec. 27, 2024, in the Korean Intellectual Property Office, the disclosure of which is incorporated herein by reference in its entirety.

### FIELD OF THE INVENTION

Example embodiments relate to an underwater acoustic signal detection method and an apparatus therefor, and one particular implementation relates to an underwater acoustic signal detection method performed by an electronic apparatus, the method including identifying, based on acoustic data obtained from an acoustic signal received underwater, a target frequency value measured at a reference point in a time-frequency domain of the acoustic data, determining whether the target frequency value is associated with tracking data related to tracking of a target detection acoustic signal included in the acoustic signal, and updating the tracking data based on the association of the target frequency value with the tracking data, in which the tracking data comprise at least one tracking channel for tracking the target detection acoustic signal and at least one single tracking frequency value determined to be measured at a point in time prior to the reference point of the acoustic data, and an apparatus therefor.

### DESCRIPTION OF THE RELATED ART

Advances in aquatic biology and marine environmental research have led to the development of various acoustic signal analysis techniques, which are playing an important role in understanding the communication and ecological behavior of marine mammals. In particular, underwater creatures such as whales and dolphins produce a variety of acoustic signals, such as whistles and clicks, for foraging, communication between individuals, or vigilance signaling.

In particular, whale whistles are nonlinear frequency-modulated signals, similar to human whistles, which can be analyzed to study the dynamics of underwater ecosystems or applied to underwater communication technologies. However, these acoustic signals can be superimposed with ocean noise, interfering signals, or acoustic signals from other organisms, resulting in complexity in the time-frequency domain. Therefore, there is a need for underwater acoustic signal tracking technology to effectively separate these superimposed acoustic signals and accurately track target detection acoustic signals such as whale whistles.

On the other hand, existing multi-target tracking-based whistle acoustic signal tracking techniques, such as Gaussian Mixture Probability Hypothesis Density (GM-PHD) and Sequential Monte Carlo Probability Hypothesis Density (SMC-PHD), have the limitation of degrading performance due to other interfering signals or failing to reliably extract whistles when superimposed with neighboring whistle signals. In addition, acoustic analysis methods based on deep neural networks are not suitable for real-time acoustic signal analysis due to high computational cost and difficulty in data labeling.

Accordingly, to address these drawbacks, there is a need for an acoustic signal analysis technology that can effectively track target detection signals such as whistles even in the presence of interfering signals while enabling real-time analysis.

In this regard, reference can be made to prior art such as KR1020220148628A.

### SUMMARY OF THE INVENTION

An aspect is to address the above-described drawbacks and provide an underwater acoustic signal detection method performed by an electronic apparatus, the method including identifying, based on acoustic data obtained from an acoustic signal received underwater, a target frequency value measured at a reference point in a time-frequency domain of the acoustic data, determining whether the target frequency value is associated with tracking data related to tracking of a target detection acoustic signal included in the acoustic signal, and updating the tracking data based on the association of the target frequency value with the tracking data, in which the tracking data comprise at least one tracking channel for tracking the target detection acoustic signal and at least one single tracking frequency value determined to be measured at a point in time prior to the reference point of the acoustic data, and an apparatus therefor.

The technical aspects of the present disclosure are not limited to those mentioned above, and other technical aspects can be inferred from the following example embodiments.

According to an aspect, there is provided an underwater acoustic signal detection method performed by an electronic apparatus, including identifying, based on acoustic data obtained from an acoustic signal received underwater, a target frequency value measured at a reference point in a time-frequency domain of the acoustic data, determining whether the target frequency value is associated with tracking data related to tracking of a target detection acoustic signal included in the acoustic signal, and updating the tracking data based on the association of the target frequency value with the tracking data. The tracking data includes at least one tracking channel for tracking the target detection acoustic signal and at least one single tracking frequency value determined to be measured at a point in time prior to the reference point of the acoustic data.

According to an example embodiment, identifying a target frequency value may include identifying the target frequency value based on a threshold value of the signal to noise ratio (SNR) of the frequency domain of the acoustic data at the reference point.

According to an example embodiment, the threshold value may be determined for each individual frequency cell of a plurality of frequency cells included in the frequency domain.

According to an example embodiment, the threshold value may be determined, for each individual frequency cell, based on signal-to-noise ratios of the individual frequency cell and a reference frequency cell corresponding to the individual frequency cell.

According to an example embodiment, the reference frequency cell may include two or more frequency cells separated by different step-sizes relative to the individual frequency cell.

According to an example embodiment, the step-size may be determined based on a frequency characteristic of the target detection acoustic signal.

According to an example embodiment, determining whether the target frequency value is associated with tracking data may include determining whether the target frequency value is associated with the tracking data based on a statistical distance between the target frequency value and an predicted frequency value at the reference point determined in response to the tracking channel included in the tracking data.

According to an example embodiment, determining whether the target frequency value is associated with tracking data may include identifying a tracking channel associated with the target frequency value from the tracking data, and, if no tracking channel associated with the target frequency value is identified, identifying a single tracking frequency value associated with the target frequency value from the tracking data.

According to an example embodiment, updating the tracking data may include assigning the target frequency value to the tracking channel associated with the target frequency value.

According to an example embodiment, updating the tracking data may include updating a status included in status information of the tracking channel associated with the target frequency value to a stabilized status.

According to an example embodiment, updating the tracking data may include determining, based on each termination condition set for each tracking channel, whether to terminate a tracking channel with which the target frequency value is determined not to be associated from the tracking data, and each termination condition may be set based on status information of each tracking channel.

According to an example embodiment, updating the tracking data may include creating a new tracking channel based on the target frequency value and the single tracking frequency value associated with the target frequency value.

According to an example embodiment, updating the tracking data may include, if the target frequency value is not associated with the tracking data, updating the tracking data to include the target frequency value as the single tracking frequency value in the tracking data.

According to an example embodiment, updating the tracking data may include calculating a predicted frequency value at the reference point corresponding to the tracking data determined not to be associated with the target frequency value from the tracking data, and including the calculated predicted frequency value as the tracking data.

According to another aspect, there is provided a non-transitory computer-readable recording medium having a program for executing an underwater acoustic signal detection method recorded thereon, the underwater acoustic signal detection method including identifying, based on acoustic data obtained from an acoustic signal received underwater, a target frequency value measured at a reference point in a time-frequency domain of the acoustic data, determining whether the target frequency value is associated with tracking data related to tracking of a target detection acoustic signal included in the acoustic signal, and updating the tracking data based on the association of the target frequency value with the tracking data, in which the tracking data include at least one tracking channel for tracking the target detection acoustic signal and at least one single tracking frequency value determined to be measured at a point in time prior to the reference point of the acoustic data.

According to yet another aspect, there is provided an electronic apparatus configured to perform an underwater acoustic signal detection method, the electronic apparatus including a transceiver, a memory, and a processor, in which the processor is configured to control at least one of the transceiver and the memory to perform identifying, based on acoustic data obtained from an acoustic signal received underwater, a target frequency value measured at a reference point in a time-frequency domain of the acoustic data, determining whether the target frequency value is associated with tracking data related to tracking of a target detection acoustic signal included in the acoustic signal, and updating the tracking data based on the association of the target frequency value with the tracking data, and the tracking data include at least one tracking channel for tracking the target detection acoustic signal and at least one single tracking frequency value determined to be measured at a point in time prior to the reference point of the acoustic data.

According to the present disclosure, target detection acoustic signals, such as whale whistles, can be effectively tracked even in the presence of interfering signals originating from underwater.

According to the present disclosure, target detection acoustic signals can be effectively separated and tracked even in situations where multiple target detection acoustic signals are overlapping or adjacent.

In particular, the underwater acoustic signal detection method of the present disclosure can be effectively applied in the field of defense for conducting communication underwater without being detected by an enemy. In underwater communication systems of the field of defense, there is a technical challenge for an underwater communication system to deliver information to friendly forces without being detected by the enemy, and accordingly, biomimetic signal research is being actively conducted to analyze the acoustic signals of cetaceans and build an underwater communication system based on them. In this regard, the underwater acoustic signal detection method of the present disclosure can be understood as a technical idea that can be easily applied to underwater communication systems for various military units by enabling signal analysis of cetaceans by separately tracking the whistles of cetaceans.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings. It is to be understood that both the foregoing general description and the following detailed description are exemplary and explanatory and are intended to provide further explanation of the invention as claimed.

### BRIEF DESCRIPTION OF THE FIGURES

The accompanying drawings, which are included to provide a further understanding of the invention and are incorporated in and constitute a part of this specification, illustrate embodiments of the invention and together with the description serve to explain the principles of the invention. In the drawings:

FIG. 1 is a schematic diagram of a system for illustrating the operation of an electronic apparatus for performing an analysis of an underwater acoustic signal according to an example embodiment of the present disclosure;

FIG. 2 is an exemplary diagram of acoustic data obtained by an electronic apparatus from an acoustic signal;

FIG. 3 is an exemplary diagram illustrating a result of an electronic apparatus tracking a target detection acoustic signal based on acoustic data;

FIG. 4 is a flowchart of an underwater acoustic signal detection method according to an example embodiment of the present disclosure;

FIG. 5 is a diagram illustrating exemplary results of determining threshold values for individual frequency cells according to an example embodiment of the present disclosure;

FIG. 6 is a diagram illustrating exemplary results of a target frequency identification performed at each time point based on a signal-to-noise ratio threshold value according to an example embodiment of the present disclosure;

FIG. 7 is a block diagram illustrating a method for calculating a threshold value suitable for multiple whistle detection using a plurality of MCA-CFAR detectors according to an example embodiment of the present disclosure;

FIG. 8 is a flowchart illustrating a target detection signal tracking procedure performed by an electronic apparatus according to an example embodiment of the present disclosure;

FIG. 9 is a flowchart illustrating a procedure for creating a new tracking channel according to an example embodiment of the present disclosure;

FIG. 10 is a flowchart illustrating a process for updating tracking data according to an example embodiment of the present disclosure;

FIG. 11 is a diagram illustrating an exemplary result of analyzing a target detection signal according to an example embodiment of the present disclosure; and

FIG. 12 is an exemplary diagram of a configuration of an electronic apparatus according to an example embodiment of the present disclosure.

### DETAILED DESCRIPTION

Reference will now be made in detail to the embodiments of the present invention, examples of which are illustrated in the accompanying drawings.

The terms used in example embodiments have been selected as general terms that are currently widely used as possible while taking functions in the present disclosure into consideration, but these may vary according to the intention of those skilled in the art, a precedent, the emergence of new technologies, and the like. In addition, in certain cases, there are terms arbitrarily selected by the applicant, and in this case, the meaning will be described in detail in the corresponding description. Therefore, the terms used in the present disclosure should be defined based on the meaning of the term and the whole contents of the present disclosure, not just the name of the term.

Throughout the specification, when it is stated that a part “comprises” or “includes” a certain component, it means that other components may further be included, and it does not preclude other components, unless otherwise stated. In addition, terms such as “ . . . part”, “ . . . module”, and the like described in the present specification mean a unit for performing at least one function or operation, which may be implemented as hardware or software, or as a combination of hardware and software.

The expression “at least one of A, B, and C” may indicate the following meaning including: A alone; B alone; C alone; both A and B together; both A and C together; both B and C together; or all three of A, B, and C together.

The “terminal” mentioned herein may be implemented as a computer or a portable terminal that can access a server or other terminal through a network. Here, the computer includes, for example, a notebook, a desktop, a laptop, and the like, equipped with a web browser, and the portable terminal is, for example, a wireless communication device that guarantees portability and mobility, which may include all kinds of handheld-based wireless communication device including communication-based terminals such as IMT (International Mobile Telecommunication), CDMA (Code Division Multiple Access), W-CDMA (W-Code Division Multiple Access), LTE (Long Term Evolution), smartphones, tablet PCs, and the like.

In the following, with reference to the accompanying drawings, example embodiments of the present disclosure will be described in detail so that those skilled in the art to which the present disclosure pertains may easily implement them. However, the present disclosure may be implemented in various different forms and is not limited to the example embodiments described herein.

Hereinafter, example embodiments of the present disclosure will be described in detail with reference to the drawings.

Detailed descriptions of technical specifications well-known in the art and unrelated directly to the present disclosure may be omitted. This aims to make the subject matter of the present disclosure clearer without obscuring them by omitting unnecessary explanations.

For the same reason, some elements are exaggerated, omitted, or simplified in the drawings and, in practice, the elements may have sizes and/or shapes different from those shown in the drawings. Throughout the drawings, the same or equivalent parts are indicated by the same reference numbers.

Advantages and features of the present disclosure and methods of accomplishing the same may be understood more readily by reference to the following detailed description of example embodiments and the accompanying drawings. The present disclosure may, however, be embodied in many different forms and should not be construed as being limited to the example embodiments disclosed hereinafter. Rather, these example embodiments are provided so that this disclosure will be thorough and complete and will fully convey the concept of the disclosure to those skilled in the art, and the present disclosure will only be defined by the appended claims. Like reference numerals refer to like elements throughout the specification.

It will be understood that each block of the flowcharts and/or block diagrams, and combinations of blocks in the flowcharts and/or block diagrams, can be implemented by computer program instructions. These computer program instructions may be provided to a processor of a general-purpose computer, special purpose computer, or other programmable data processing apparatus, such that the instructions which are executed via the processor of the computer or other programmable data processing apparatus create means for implementing the functions/acts specified in the flowcharts and/or block diagrams. These computer program instructions may also be stored in a non-transitory computer-readable memory that can direct a computer or other programmable data processing apparatus to function in a particular manner, such that the instructions stored in the non-transitory computer-readable memory produce articles of manufacture embedding instruction means which implement the function/act specified in the flowcharts and/or block diagrams. The computer program instructions may also be loaded onto a computer or other programmable data processing apparatus to cause a series of operational steps to be performed on the computer or other programmable apparatus to produce a computer implemented process such that the instructions which are executed on the computer or other programmable apparatus provide steps for implementing the functions/acts specified in the flowcharts and/or block diagrams.

Furthermore, the respective block diagrams may illustrate parts of modules, segments, or codes including at least one or more executable instructions for performing specific logic function(s). Moreover, it should be noted that the functions of the blocks may be performed in a different order in several modifications. For example, two successive blocks may be performed substantially at the same time, or may be performed in reverse order according to their functions.

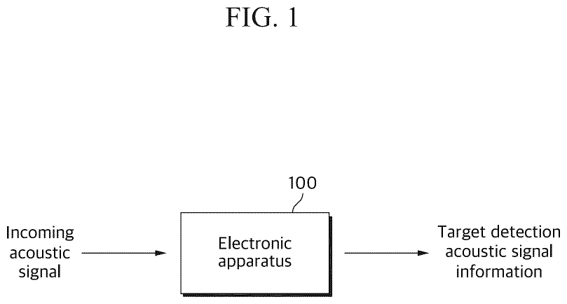

FIG. 1 is a schematic diagram of a system for illustrating the operation of an electronic apparatus for performing an analysis of an underwater acoustic signal according to an example embodiment of the present disclosure.

Referring to FIG. 1, an electronic apparatus 100 receives an incoming acoustic signal, analyzes and processes it, and outputs target detection acoustic signal information.

The electronic apparatus 100 may include, for example, a computing device, a mobile communication terminal, and a server. In an example embodiment, the incoming acoustic signal may be received underwater, and may include information of a target detection acoustic signal generated underwater. As used herein, a “target detection acoustic signal” is an acoustic signal that is the object of detection, which may be an acoustic signal having nonlinear frequency modulation characteristics, such as whistle signals from whales or dolphins and biomimetic signals, for example.

The electronic apparatus 100 may obtain acoustic data from the received acoustic signal. The “acoustic data” may be data regarding acoustic information such as measurement time, amplitude, and frequency of the received acoustic signal.

The underwater acoustic signals may be received in various ways, such as through acoustic sensors inside or outside the electronic apparatus 100, and may be recorded in the form of raw data in the time-amplitude domain. In an example embodiment, the electronic apparatus 100 may apply a Fourier transform, such as a Short-Time Fourier Transform (STFT), to the raw data to characterize the acoustic data in the time-frequency domain.

The electronic apparatus 100 may output information about the target detection acoustic signal from the obtained acoustic data.

In an example embodiment, the information about the target detection acoustic signals output by the electronic apparatus 100 may be information obtained by removing interfering signals in the time-frequency domain of obtained acoustic data and separately tracking multiple overlapping or adjacent target detection acoustic signals.

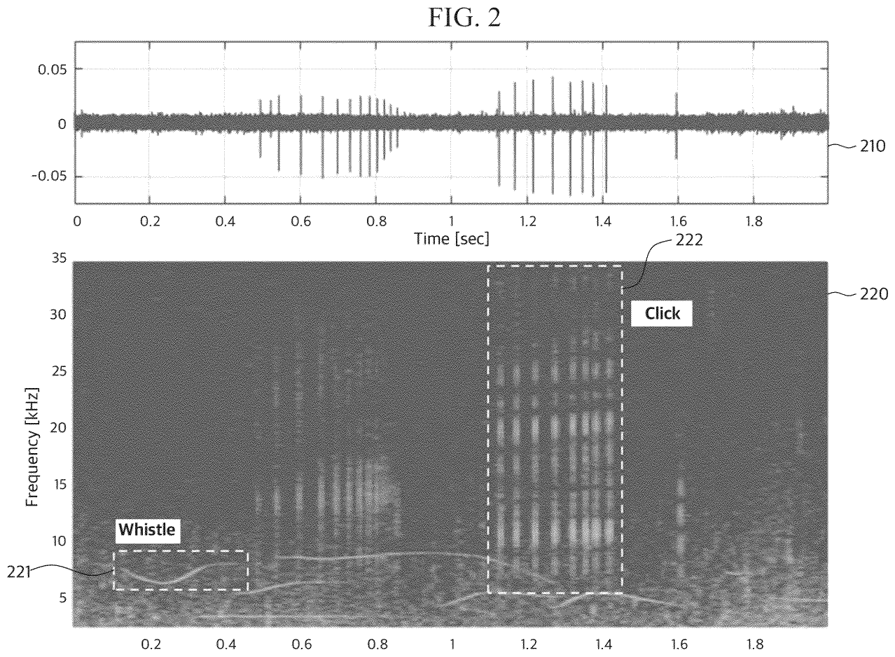

FIG. 2 is an exemplary diagram of acoustic data obtained by an electronic apparatus from an acoustic signal.

As described above, the underwater acoustic signals may be recorded as data 210 in the time-amplitude domain, and the electronic apparatus 100 may apply a Fourier transform, such as the STFT, to the data in the time-amplitude domain to obtain a spectrogram 220 in the time-frequency domain.

In an example embodiment, acoustic signals received underwater may include a whistle signal 221 and a click signal 222 from cetaceans, and may include various other interfering signals. As shown in FIG. 2, the whistle signal 221 is characterized by being measured in a narrow frequency domain over a relatively long period of time, and the click signal 222 is characterized by being measured in a large frequency domain over a short period of time, as evidenced by the spectrogram 200 in the time-frequency domain of the acoustic data, and the electronic apparatus 100 can track the whistle signal 221 as a target detection acoustic signal based on the characteristics of the whistle signal 221 in the time-frequency domain of the acoustic data.

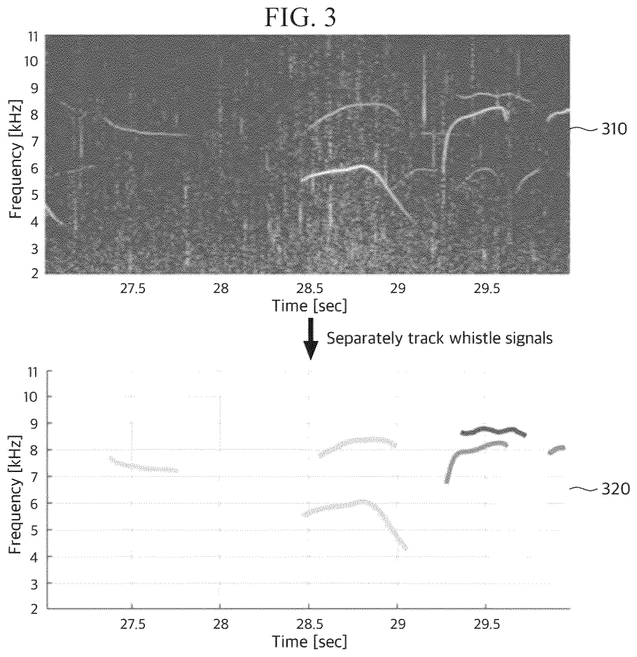

FIG. 3 is an exemplary diagram illustrating a result of an electronic apparatus tracking a target detection acoustic signal based on acoustic data.

Referring to FIG. 3, the electronic apparatus 100 may convert the underwater acoustic signal into a spectrogram 310 in the time-frequency domain, track the whistle signals appearing in the spectrogram 310 as target detection acoustic signals, and output data 320 in which the multiple whistle signals are separately tracked.

In the data 320 in which the multiple whistle signals are separately tracked, the tracked target detection acoustic signals may be whistle signals of cetaceans, and different whistle signals may be separately tracked and identified as different signals.

How the electronic apparatus 100 tracks the target detection signals in the acoustic data will be described in more detail below.

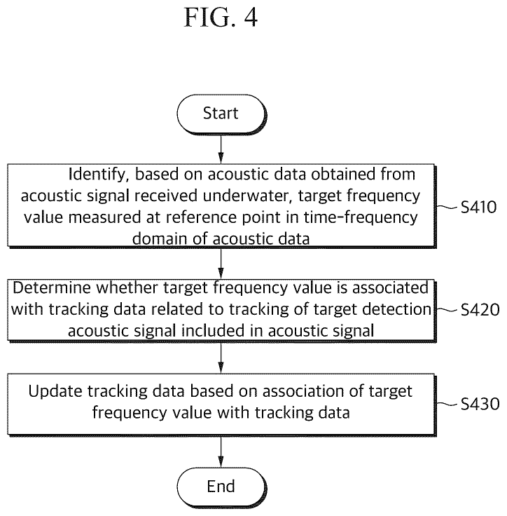

FIG. 4 is a flowchart of an underwater acoustic signal detection method according to an example embodiment of the present disclosure.

As shown in FIG. 4, an underwater acoustic signal detection method according to the present disclosure may include identifying, based on acoustic data obtained from an acoustic signal received underwater, a target frequency value measured at a reference point in a time-frequency domain of the acoustic data (S410), determining whether the target frequency value is associated with tracking data related to tracking of a target detection acoustic signal included in the acoustic signal (S420), and updating the tracking data based on the association of the target frequency value with the tracking data (S430).

In operation S410, the electronic apparatus 100 identifies, based on the acoustic data obtained from the acoustic signal received underwater, a target frequency value measured at a reference point in the time-frequency domain of the acoustic data. Here, the “target frequency value” may be a frequency value associated with tracking of a target detection acoustic signal in the acoustic data obtained from the underwater acoustic signal.

In an example embodiment, the electronic apparatus 100 may identify the target frequency value based on a threshold value of the signal to noise ratio (SNR) of the frequency domain of the acoustic data at the reference point. If the target detection acoustic signal has a narrow frequency domain over a long time span, the electronic apparatus 100 can effectively detect an instantaneous frequency value corresponding to the target detection acoustic signal by identifying the target frequency value based on a threshold value of the signal to noise ratio of the frequency domain of the acoustic data at the reference point. For example, as shown in spectrogram 220 in FIG. 2, if the electronic apparatus 100 detects a whistle as a target detection acoustic signal, it can reduce false positives for clicks 222 that include a wide frequency range at the reference point and significantly improve the detection probability of whistles 221 that have a narrow frequency range.

Determining the signal-to-noise ratio threshold value at the reference point by the electronic apparatus 100 may include estimating a noise level for a given frequency cell in the frequency domain. Depending on the method of estimating the noise level performed by the electronic apparatus 100 for the frequency cell, constant false alarm rate (CFAR) detection may be performed based on one of the following methods: cell-averaging (CA), ordered-statistics (OS), greatest of (GO), smallest of (SO), and minimum cell-averaging (MCA).

CFAR detection, as performed by the electronic apparatus 100 in this disclosure, can be understood as an algorithm for excluding noise from acoustic data and detecting a target signal, which is a method of detecting acoustic signals designed to maintain a constant false alarm rate to determine the presence of a particular signal in a noisy environment.

In an example embodiment, the electronic apparatus 100 may estimate, for each individual frequency cell in the frequency domain of the acoustic data, the noise level of the individual frequency cell, and calculate a threshold value based on the estimated noise level. The threshold values that the electronic apparatus 100 determines for each of the individual frequency cells can be understood as adaptive thresholds for the frequency domain of the acoustic data. If the electronic apparatus 100 identifies the target frequency value through the threshold values determined for each of the individual frequency cells in this way, the probability of false positives may be reduced compared to detection methods that apply specific thresholds over the entire frequency domain, and additional processing to suppress noise signals in the acoustic data may not be required, allowing for efficient real-time target signal detection.

In an example embodiment, the electronic apparatus 100 may determine, for each individual frequency cell in the frequency domain of the acoustic data, a corresponding reference frequency cell and determine a threshold value for the individual frequency cell based on a signal-to-noise ratio value of the reference frequency cell. For example, when the electronic apparatus 100 is performing MCA-CFAR detection for the frequency signal-to-noise ratio of the acoustic data to identify a target frequency value, a process of removing interfering signals within the reference frequency cell may be performed before determining the threshold value. The interfering signals may include other target signals other than the target frequency currently being identified, ocean ambient noise, clicks, etc. The method of removing the interfering signals may include repeating, for each individual frequency cell in the frequency domain of the acoustic data, the process of referencing a nearby reference frequency cell that is a set step-size away from the frequency cell, keeping the smaller of the two, and discarding the larger. After such removing of interfering signals, the threshold value of that individual frequency cell can be determined. This prevents the threshold value from being set too high for reasons such as the inclusion of the target signal in the individual frequency cell.

In an example embodiment, the electronic apparatus 100 may determine the threshold value of the signal-to-noise ratio for each frequency cell using two or more frequency cells separated by different step-sizes relative to the individual frequency cell as reference frequency cells. For example, when the electronic apparatus 100 performs MCA-CFAR detection for the frequency signal-to-noise ratio of the acoustic data to identify a target frequency value, the results of a plurality of MCA-CFAR detections with different step-sizes centered on the individual frequency cell can be integrated to determine an optimal threshold value for the individual frequency cell. In a related example embodiment, the results of the plurality of MCA-CFAR detections may complement each other where the threshold value is increased by a single MCA-CFAR, thereby preventing the threshold value for that frequency cell from being set excessively high even when the target signal is detected at intervals corresponding to the step-size of the single MCA-CFAR.

In an example embodiment, the step-size set by the electronic apparatus 100 with respect to the individual frequency cell may be determined based on characteristics of the target detection acoustic signal. The characteristics of the target detection acoustic signal may include, for example, at least one of a frequency distance between target detection acoustic signals identified based on detection history and a frequency range of the individual detection acoustic signal.

In operation S420, the electronic apparatus 100 determines whether the target frequency value is associated with the tracking data related to tracking of the target detection acoustic signal included in the acoustic signals.

As used in the present disclosure, “tracking data” may be a data structure used for managing and tracking the target detection acoustic signal within the acoustic data. For example, the tracking data may include data measured at a point in time prior to the reference point at which the electronic apparatus 100 identifies the target frequency value. The electronic apparatus 100 may check the data association of the one or more target frequency values determined to be measured at the reference point with the tracking data and update the tracking information for the target detection acoustic signal.

In an example embodiment, the tracking data may include at least one tracking channel for tracking the target detection acoustic signal and at least one single tracking frequency value determined to be measured at a point in time prior to the reference point of the acoustic data.

As used in the present disclosure, a “tracking channel” may be a dataset formed for managing and tracking the target detection acoustic signal within the acoustic data. The tracking channel may include a plurality of frequency values identified as being associated with an individual target detection acoustic signal, for example, at a time point prior to the reference point at which the electronic apparatus 100 identifies the target frequency value. The electronic apparatus 100 may determine whether the target frequency value is associated with the tracking channel at the reference point to determine whether the target frequency value is associated with the target detection acoustic signal corresponding to the tracking channel. Accordingly, the electronic apparatus 100 may update the data within the tracking channel, or create a new tracking channel if necessary, to continuously manage the target detection acoustic signal.

As used in the present disclosure, a “single tracking frequency value” may be a single frequency value representative of a frequency characteristic of the target detection acoustic signal. The electronic apparatus 100 may define the target frequency value as a single tracking frequency value and store it as new tracking data if there is no tracking data associated with the target frequency value at the reference point. As the ongoing target detection acoustic signal tracking by the electronic apparatus 100 proceeds, if a frequency value associated with the single tracking frequency value is further identified at a later point in time, the electronic apparatus 100 may create a tracking channel that includes the single tracking frequency and the newly identified target frequency values.

In an example embodiment, in determining the association of the target frequency value with the tracking data, the electronic apparatus 100 may determine whether the target frequency value is associated with the tracking data based on a statistical distance between the target frequency value and the predicted frequency value at a reference point determined in response to the tracking channel included in the tracking data.

In an example embodiment, the electronic apparatus 100 may apply a linear Kalman filter to the data included in the tracking channel to obtain the predicted frequency value at the reference point determined corresponding to the tracking channel. The electronic apparatus 100 may apply the linear Kalman filter to calculate the predicted frequency value at the reference point based on the frequency data from a previous point in time when the tracking channel was recorded and the frequency change characteristics. In an example embodiment, the system model of the linear Kalman filter may be expressed as shown in Equation 1 below.

$$\begin{matrix}{x}_{k + 1} = {Ax}_{k} + {w}_{k} , & {z}_{k} = {Hx}_{k} + {v}_{k} .\end{matrix} \qquad [ Equation 1 ]$$

In Equation 1 above, xₖ may be a state variable (2×1) consisting of a frequency and a frequency change, zₖ may be a measurement value (1×1), A may be a system matrix (2×2), H may be an output matrix (1×2), wₖ may be system noise (2×1), and vₖ may be measurement noise (1×1). In an example embodiment, the system matrix A and the output matrix H may be set as shown in Equation 2 below.

$$A = [ \begin{matrix}1 & dt \\ 0 & 1\end{matrix} ] , H = [ 1 , 0 ] . \qquad [ Equation 2 ]$$

Here, dt may be a time interval (tₖ₊₁−tₖ), and the system noise wₖ and measurement noise vₖ may be modeled as, but are not limited to, random noise, such as a Gaussian distribution. In this example embodiment, the electronic apparatus 100 uses the previous state variable xₖ and the system matrix A shown in Equation 1 above to calculate a predicted frequency value at the reference point, and uses the actual measured frequency value zₖ to modify the predicted value.

In determining whether the target frequency value is associated with the tracking data based on the statistical distance between the predicted frequency value and the target frequency value, the electronic apparatus 100 may assign the target frequency value at the reference point to the tracking channel by calculating an approximate associate probability.

In an example embodiment, the electronic apparatus 100 may determine the association of the target frequency value with the tracking channel based on, for example, a Nearest-Neighbor Joint Probabilistic Data Association (NNJPDA) method.

The statistical distance dᵢⱼ between the target frequency value and the predicted frequency value at the reference point determined in response to the tracking channel may be obtained as shown in Equation 3 below.

$${d}_{ij} = \frac{{e}_{ij}}{{V}_{G}} \qquad [ Equation 3 ]$$

In Equation 3 above, eᵢⱼ may be the distance between the predicted frequency value and the identified target frequency value, and G may be the gate size. For a matrix D with entries dᵢⱼ, the electronic apparatus 100 may calculate a matrix P with entries pᵢⱼ based on Equation 4 below.

$${p}_{ij} = exp ( - {d}_{ij}^{2} ) \qquad [ Equation 4 ]$$

In Equation 4 above, pᵢⱼ is a pseudo probability value corresponding to the statistical distance dᵢⱼ, which can be understood as a value converted from the statistical distance dᵢⱼ into a value similar to probability, and it may have a value between 0 and 1. To determine the data association based on the NNJPDA, the electronic apparatus 100 may normalize the pseudo probability pᵢⱼ as shown in Equation 5 below to calculate the normalized probability qᵢⱼ, and obtain a matrix Q with entries qᵢⱼ.

$${q}_{ij} = \frac{{p}_{ij}}{{\sum }_{i} + {\sum }_{j} - {p}_{ij}} , {\sum }_{i} = {\sum }_{j = 1}^{{N}_{t}} {p}_{ij} \cdot {\sum }_{j} = {\sum }_{i = 1}^{{N}_{m}} {p}_{ij} \qquad [ Equation 5 ]$$

In Equation 5 above, Nₜ may be the number of tracking channels included in the tracking data, and Nₘ may be the number of single tracking frequency values included in the tracking data.

In an example embodiment, the electronic apparatus 100 may identify a tracking channel associated with the target frequency value in the tracking data, and if no tracking channel associated with the target frequency value is identified, it may identify a single tracking frequency value associated with the target frequency value in the tracking data. In other words, in determining whether the target frequency value is associated with multiple tracking data (tracking channels and single tracking frequency values), the electronic apparatus 100 may prioritize the tracking channel over the single tracking frequency, and only determine whether the single tracking frequency value is associated with the target frequency value if no tracking channel is associated with the target frequency value. This allows the electronic apparatus 100 to prioritize updating an existing tracking channel over creating a new tracking channel, and to update the tracking data appropriately based on the target frequency value.

As used in this disclosure, the association of a target frequency value with a tracking channel may be referred to as a “frequency-channel association” and the association of a target frequency value with a single tracking frequency value may be referred to as a “frequency-frequency association”.

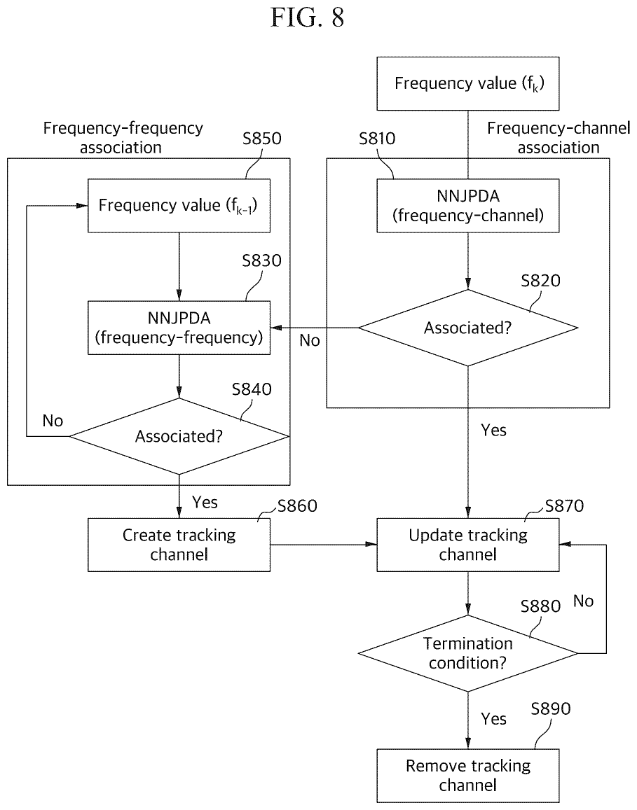

In summary, the electronic apparatus 100 may first determine the frequency-channel association for the target frequency value, and if the frequency-channel association cannot be identified, the frequency-frequency association may be determined, as will be described in more detail below with reference to FIG. 8.

In operation S430, the electronic apparatus 100 updates the tracking data based on the association of the target frequency value with the tracking data. By updating the tracking data, the electronic apparatus 100 can track information of the target detection acoustic signal.

In an example embodiment, updating the tracking data by the electronic apparatus 100 may include at least one of: assigning the target frequency value to the tracking channel associated with the target frequency value; creating a new tracking channel based on the target frequency value and a single tracking frequency value to which the target frequency value is associated; if the tracking data is not associated with the target frequency value, updating the tracking data to include the target frequency value as a single tracking frequency value in the tracking data; and updating the tracking data to include an predicted frequency at the reference point for the tracking data that is not associated with the target frequency value.

The electronic apparatus 100 assigning the target frequency value to a tracking channel associated with the target frequency value may mean that the target frequency value is incorporated into that channel based on a determination of its association with an existing tracking channel. For example, assigning the target frequency value to the tracking channel by the electronic apparatus 100 may include adding the target frequency value to a list of frequency values of the tracking channel to which it is assigned, and updating a state variable of the tracking channel including at least one of a mean, a variance, and a frequency change rate of the frequency values of the tracking channel based on the target frequency value.

Creating a new tracking channel based on the target frequency value and a single tracking frequency value to which the target frequency value is associated may be creating a tracking channel using two associated frequency values. To do this, the electronic apparatus 100 may set a state vector initial value including the frequency change amount of two frequency values and the target frequency value at the reference point.

In updating the tracking data to include the target frequency value as a single tracking frequency value in the tracking data, the target frequency value may be stored as a single tracking frequency value that is not included in the tracking channel and utilized as tracking data in a subsequent target detection acoustic signal tracking process. In an example embodiment, the electronic apparatus 100 may determine the association of the newly included single tracking frequency value at the reference point with the subsequently identified target frequencies.

In an example embodiment, the electronic apparatus 100 may, in updating the tracking data, to update the tracking data to include a predicted frequency at the reference point for the tracking data not associated with the target frequency value, calculate a predicted frequency value for the reference point corresponding to the tracking data determined not to be associated with the target frequency value from among the tracking data, and include the calculated predicted frequency value as the tracking data. Here, the linear Kalman filter described above may be utilized by the electronic apparatus 100 to calculate the predicted frequency at the reference point for the tracking data. As used in this disclosure, the sequence of actions of the electronic apparatus 100 to include the predicted frequency value at the reference point in the tracking data for the tracking data that is not associated with the target frequency value may be referred to as “memory track”. By adding data from a corresponding reference point to the tracking data for the tracking data that is not associated at the reference point via the memory track, the electronic apparatus 100 may perform tracking by determining the data association for the frequency value obtained at a subsequent point in time from the reference point with that tracking data, and continue tracking for tracking channels and frequencies that are not associated with the target frequency obtained at the reference point, but for which the tracking has not been terminated because the termination condition is not satisfied.

In an example embodiment, the tracking channel included in the tracking data may have corresponding status information, and in updating the tracking data, the electronic apparatus 100 may update the status included in the status information of the tracking channel to which the target frequency value is associated to a stabilized state.

In an example embodiment, the status information of the tracking channel may include status information related to at least one of a number of times that the target frequency value identified at each tracking time point is determined to be associated with the corresponding tracking channel (update count) and a number of times that the target frequency value identified at each tracking time point is determined not to be associated with the corresponding tracking channel (non-update count).

In an example embodiment, the electronic apparatus 100 may update the status information of the tracking channel to a stabilized state as the number of updates of each tracking channel increases.

In an example embodiment, the electronic apparatus 100 may determine whether to terminate a tracking channel with which a target frequency value is found to be unassociated in the tracking data based on a respective termination condition set for each tracking channel. In this case, the termination condition may be set based on status information of each tracking channel. For example, if the non-update count at successive tracking points of a tracking channel reaches a value set according to the termination condition, the electronic apparatus 100 may determine to terminate the corresponding tracking channel, and the termination condition may be set to be terminated by a higher number of non-updates, as the state of each channel becomes more stabilized.

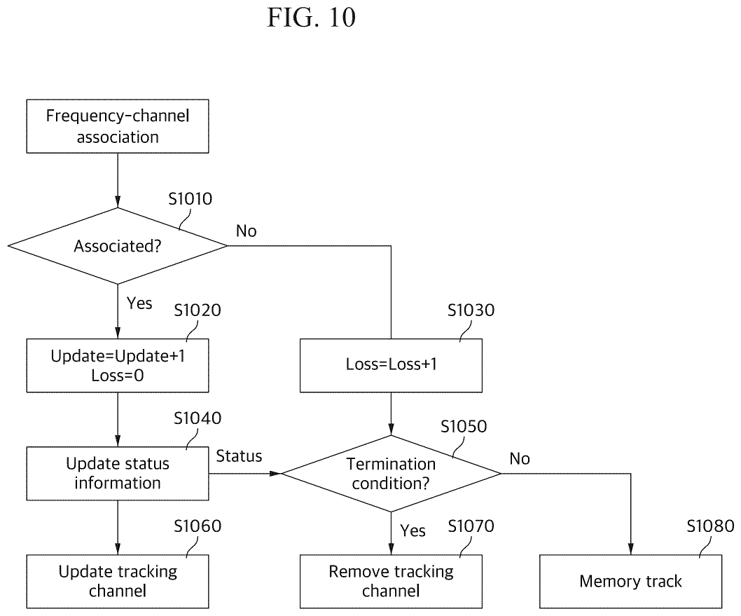

Specific example embodiments related to the status information of the tracking channel are described in more detail below with reference to FIG. 10 and Tables 1 and 2.

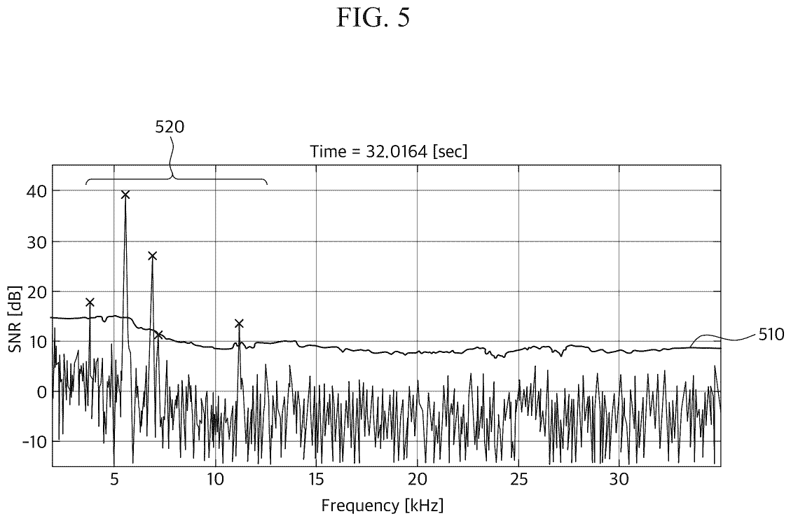

FIG. 5 is a diagram illustrating exemplary results of determining threshold values for individual frequency cells according to an example embodiment of the present disclosure.

Referring to FIG. 5, signal-to-noise ratio (SNR) by frequency band at a reference time (t=32.0164 sec) is shown, in which the x-axis shows frequency (in kHz), the y-axis shows signal-to-noise ratio (in dB), and the signal-to-noise ratio threshold value 510 determined for each frequency cell is plotted.

The signal-to-noise ratio threshold value 510 shows the result of integrating the results of a plurality of MCA-CFAR detections with different step-sizes for each of the individual frequency cells to determine an optimal threshold value for the individual frequency cell. Accordingly, the signal-to-noise ratio threshold value 510 forms an adaptive threshold value rather than a fixed value, for the frequency domain, and it is stable and does not become excessively high even when the target acoustic signal 520 is detected.

The electronic apparatus 100 may identify the frequency of target acoustic signal 520 having a signal-to-noise ratio occurring above the threshold value 510 as the target frequency value associated with the target detected acoustic signal.

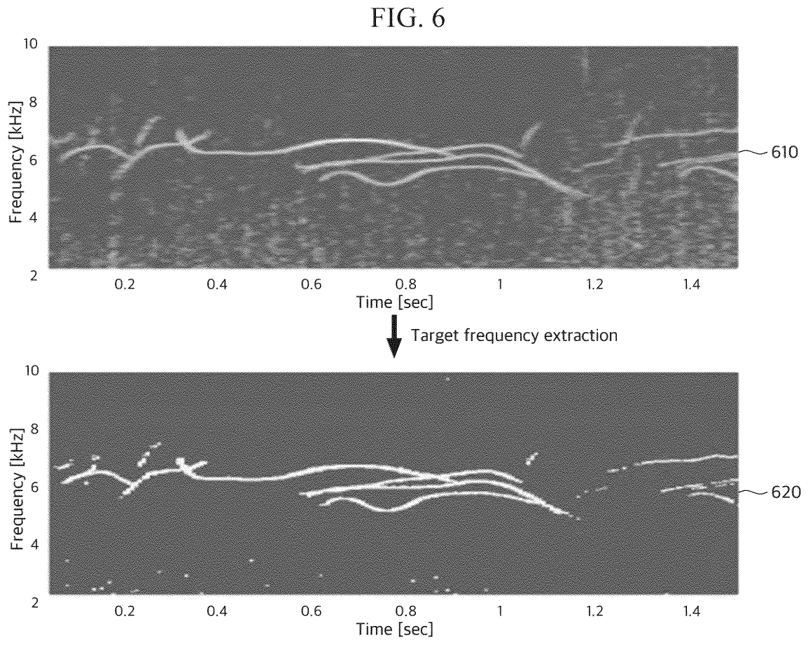

FIG. 6 is a diagram illustrating exemplary results of a target frequency identification performed at each time point based on a signal-to-noise ratio threshold value according to an example embodiment of the present disclosure.

The target frequency extraction operation illustrated in FIG. 6 may be a process of removing noise from the acoustic data by extracting the target frequency identified at each time point by the electronic apparatus 100 in response to operation S410 of FIG. 4.

Referring to FIG. 6, the electronic apparatus 100 may generate a time-frequency domain spectrogram 610 of the obtained underwater acoustic data and analyze it to identify and extract the target frequency.

The time-frequency domain spectrogram 610 of the acoustic data may be cluttered in the time-frequency domain due to overlaps with ocean noise, interfering signals, or acoustic signals from other organisms. The electronic apparatus 100 may identify the target frequency based on a signal-to-noise ratio threshold value for the spectrogram 610, and may obtain a spectrogram 620 that extracts the identified target frequency at each time point, according to an example embodiment.

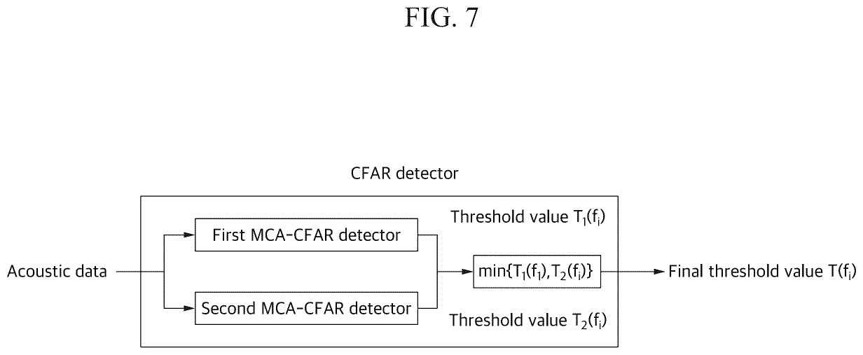

FIG. 7 is a block diagram illustrating a method for calculating a threshold value suitable for multiple whistle detection using a plurality of MCA-CFAR detectors according to an example embodiment of the present disclosure.

While conventional MCA-CFAR for target signal detection has low computation and is suitable for multi-target tracking, it suffers from the problem that when there are multiple targets spaced at intervals corresponding to the step-sizes set for each MCA-CFAR, the threshold value increases excessively and does not accurately detect the target signal in an environment with multiple target detection signals. As an example embodiment to address this drawback, the electronic apparatus 100 may determine the lesser of the threshold results of the MCA-CFAR detectors of different plurality of step-sizes as the final threshold value for each frequency cell.

Referring to FIG. 7, the electronic apparatus 100 inputs acoustic data obtained from the incoming acoustic signal into a CFAR detector including a first MCA-CFAR detector and a second MCA-CFAR detector. The first MCA-CFAR detector and the second MCA-CFAR detector may each output threshold values T₁(ƒₜ) and T₂(ƒᵢ) for an individual frequency cell corresponding to the frequency ƒᵢ, and the CFAR detector may determine the smaller threshold value between T₁(ƒᵢ) and T₂(ƒᵢ) as a final threshold value. In this example embodiment, the first MCA-CFAR detector and the second MCA-CFAR detector may compensate for excessive threshold increases caused by target detection acoustic signals or the like.

While FIG. 7 illustrates the CFAR detector with two MCA-CFAR detectors for convenience, a CFAR detector may include more than two MCA-CFAR detectors, and may include a plurality of MCA-CFAR detectors operating in complementary fashion.

FIG. 8 is a flowchart illustrating a target detection signal tracking procedure performed by an electronic apparatus according to an example embodiment of the present disclosure.

A tracking procedure according to the present disclosure may include managing a tracking channel for tracking a frequency of a target detection signal over time by determining whether a target frequency value is associated with tracking data for tracking of the target detection signal performed by the electronic apparatus 100.

Referring to FIG. 8, for an identified target frequency value ƒₖ, association of the target frequency value ƒₖ with a tracking channel (frequency-channel association) may be determined (S820) based on a statistical distance between the target frequency value and a predicted frequency value at a reference point (t=k). At this time, the electronic apparatus 100 may perform an NNJPDA-based association algorithm for the tracking channel with respect to the target frequency value ƒₖ, as described above with reference to Equations 1 to 5 (S810). If the target frequency value ƒₖ is determined to be associated with the tracking channel based on the frequency-channel association, the electronic apparatus 100 may perform an update to the tracking channel included in the tracking data without determining the frequency-frequency association (S870).

The electronic apparatus 100 may determine the association of the target frequency value ƒₖ with a single tracking frequency ƒₖ₋₁ (frequency-frequency association) based on a statistical distance from the single tracking frequency ƒₖ₋₁ for the target frequency value ƒₖ that is determined not to be associated with the tracking channel (S840). At this time, the electronic apparatus 100 may perform an NNJPDA-based association algorithm for the single tracking frequency ƒₖ₋₁ with respect to the target frequency value ƒₖ, as described above with reference to Equations 1 through 5 (S830).

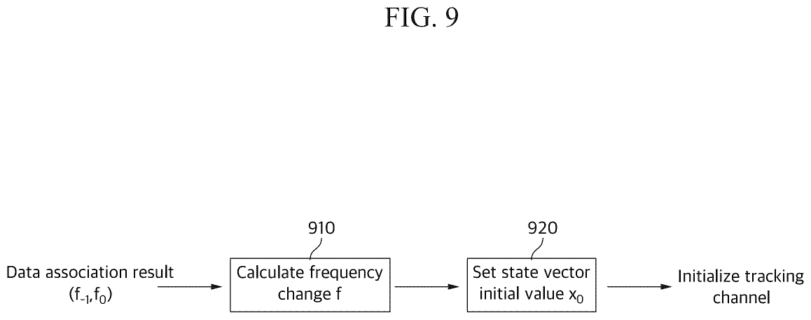

The electronic apparatus 100 may perform the association algorithm again with a different target frequency value ƒₖ that is not associated with the single tracking frequency ƒₖ₋₁ (S850) or, if the target frequency value ƒₖ is associated with the single tracking frequency ƒₖ₋₁, it may create a new tracking channel (S860). How the electronic apparatus 100 creates a new tracking channel is described in more detail with reference to FIG. 9.

If the target frequency value ƒₖ is determined to be associated with the tracking channel (frequency-channel association) (S820), or if a new tracking channel is created because the target frequency value ƒₖ is determined to be associated with a single tracking frequency ƒₖ₋₁ (frequency-frequency association) (S860), the electronic apparatus 100 performs an update to the tracking channels included in the tracking data (S870). Tracking channel update may include updating the status information of the tracking channel determined to be frequency-channel associated with the target frequency value to a stabilized state, and updating the variable associated with the termination condition of the tracking channel determined not to be frequency-channel associated.

The electronic apparatus 100 then determines the termination condition for each tracking channel (S880). In an example embodiment, the electronic apparatus 100 may update the tracking data by calculating a predicted frequency value for a reference point corresponding to the tracking channel, and including it in the tracking data, for the tracking data that has not been assigned the target frequency value ƒₖ but has not satisfied the termination condition for the tracking channel from among the tracking data.

In operation S890, the electronic apparatus 100 removes the tracking channel that satisfies the termination condition.

By the method illustrated in FIG. 8, the electronic apparatus 100 updates the tracking channel by performing channel-frequency association when a target frequency value is identified, and creates a tracking channel by determining a frequency-frequency association for a single tracking frequency value with respect to the unassociated measurements. It can be understood that the newly identified target frequency value is first assigned to the tracking channel of the target detection acoustic signal being tracked by the existing whistle, and then the unassigned target frequency value is utilized to create the tracking channel. The tracking channel that is not assigned the target frequency value updates the tracking channel with its own predicted value via the memory track. Accordingly, the electronic apparatus 100 may prioritize the update of the existing tracking channel over the creation of a new channel.

FIG. 9 is a flowchart illustrating a procedure for creating a new tracking channel according to an example embodiment of the present disclosure.

The process of creating a new tracking channel illustrated in FIG. 9 may correspond to operation S860 illustrated in FIG. 8. As described above with reference to FIG. 8, if the target frequency value ƒₖ is associated with a single tracking frequency ƒₖ₋₁, the electronic apparatus 100 creates a new tracking channel. Creation of the new tracking channel by the electronic apparatus 100 may be performed based on Equation 6 below.

$$\dot{f} = \frac{{f}_{0} - {f}_{- 1}}{Δ t} , {x}_{0} = [ \begin{matrix}{f}_{0} \\ \dot{f}\end{matrix} ] . \qquad [ Equation 6 ]$$

In Equation 6 above, ƒ₀ may be the target frequency value identified at the current time point, and ƒ₋₁ may be a single tracking frequency value included in the tracking data because it was not associated with the tracking data at a previous time point. As shown in Equation 6, the electronic apparatus 100 may create the tracking channel by calculating an initial value x₀ of the state vector based on ƒ₀ and ƒ₋₁.

FIG. 10 is a flowchart illustrating a process for updating tracking data according to an example embodiment of the present disclosure.

In an example embodiment, the tracking channels included in the tracking data may have corresponding status information, and the electronic apparatus 100 may, in updating the tracking data, update a status included in the status information of a tracking channel to which a target frequency value is associated to a stabilized state, or update a variable associated with a termination condition of a tracking channel to which no target frequency value is associated. The termination condition may be determined based on the status information of each tracking channel.

In an example embodiment, the status information corresponding to each tracking channel may include a stabilization variable (Update) and a termination condition variable (Loss), and the electronic apparatus 100 may update the status information of the tracking channel according to the method illustrated in FIG. 10 in updating the tracking data.

Referring to FIG. 10, the electronic apparatus 100 may perform an operation of adding 1 to the Update variable and resetting the Loss variable to 0 for the tracking channel determined to be frequency-channel associated for the identified target frequency value (S1020), and performing an operation of adding 1 to the Loss variable for the tracking channel determined not to be frequency-channel associated for the target frequency value (S1030).

The electronic apparatus 100 updates status information for the tracking channel for which the Update variable and the Loss variable have been updated according to operation S1020 (S1040). The status information may be information about how stabilized each tracking channel is, and may include status information in a format such as Table 1 below.

TABLE 1

| Status | | Determination method |
|---|---|---|
| Status 1 | Tracking initialization | Update ≥ 1 |
| Status 2 | Channel stabilization | Update ≥ 2 |
| | phase 1 | |
| Status 3 | Channel stabilization | Update ≥ 4 |
| | phase 2 | |
| Status 4 | Tracking channel removal/ | Follow removal condition |
| | termination | |

Referring to Table 1 above, a tracking channel included in the tracking data may be determined to be in one of tracking initialization status (Status 1), channel stabilization phase 1 (Status 2), and channel stabilization phase 2 (Status 3), and a tracking channel satisfying the removal condition of the tracking channel may be determined to be in removal and termination phase (Status 4) of the tracking channel. However, the variables and status information of the tracking channel shown in Table 1 above are examples related to the stabilization status of the tracking channel, and the tracking data is not limited to the form shown in Table 1.

Referring to Table 1, it can be understood that as the Update variable increases, the stabilization phase of the status of the tracking channel increases, and the tracking channel with a higher stabilization phase has more assigned frequency values, indicating that the tracking channel is stabilized.

In operation S1050, the electronic apparatus 100 may determine whether to terminate a tracking channel for which the target frequency value is found not to be associated in the tracking data. The determination of whether to terminate the tracking channel may be based on whether each tracking channel satisfies the termination condition, in which each termination condition is set based on status information of each tracking channel, and may be set, for example, as shown in Table 2 below.

TABLE 2

| Status | | Removal condition |
|---|---|---|
| Status 1 | Tracking initialization | Loss ≥ 1 |
| Status 2 | Channel stabilization | Loss ≥ 2 |
| | phase 1 | |
| Status 3 | Channel stabilization | Loss ≥ 4 |
| | phase 2 | |
| Status 4 | Tracking channel removal/ | — |
| | termination | |

Referring to Table 2 above, if the Loss variable corresponding to each tracking channel exceeds the set value, the tracking channel is determined to satisfy the termination condition, and a higher Loss variable may be assigned to each tracking channel as it corresponds to a more stabilized stage in response to the stabilization stage of each tracking channel. Accordingly, the electronic apparatus 100 may be set to perform more tracking for more stabilized tracking channels.

Based on the determination of the termination condition in operation S1050, the electronic apparatus 100 removes the corresponding tracking channel (S1070) or retains it to perform the memory track (S1080).

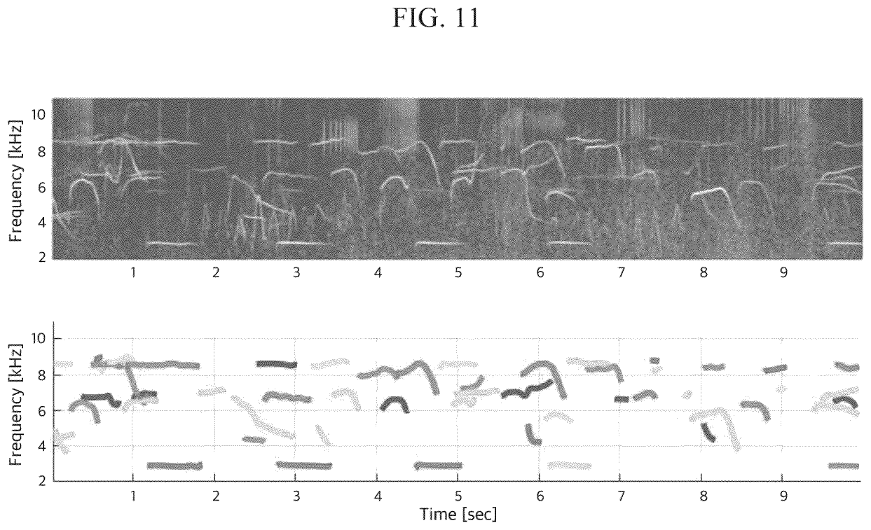

FIG. 11 is a diagram illustrating an exemplary result of analyzing a target detection signal according to an example embodiment of the present disclosure.

FIG. 11 is an underwater acoustic signal detected underwater, which is the result of separately tracking whistle signals of cetaceans against noise signals and click signals of cetaceans. As shown in FIG. 11, whistle signals can be separately tracked against clicks and noise, even in a noisy environment where multiple noise signals are present, and target signal detection can be performed such that multiple whistle signals are distinguished from each other, according to the target signal detection method in accordance with the present disclosure.

Separately tracking the whistle signals may mean, for example, in situations where different whistle signals are superimposed by multiple cetaceans, each signal is individually tracked as a separate signal.

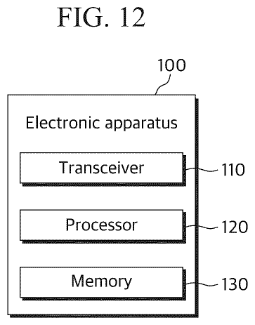

FIG. 12 is an exemplary diagram of a configuration of an electronic apparatus according to an example embodiment of the present disclosure.

Referring to FIG. 12, the electronic apparatus 100 may include a transceiver 110, a processor 120, and a memory 130. The electronic apparatus 100 may be connected to user external devices through the transceiver 110, and may exchange data therewith.

The processor 120 may include at least one apparatus described above with reference to FIGS. 1 to 11, or it may perform at least one method described above with reference to FIGS. 1 to 11. The memory 130 may store information for performing at least one method described above with reference to FIGS. 1 to 11. The memory 130 may be a volatile memory or a non-volatile memory.

The processor 120 may control the electronic apparatus 100 to execute a program and provide information. The code of the program executed by the processor 120 may be stored in the memory 130.

Also, the electronic apparatus 100 according to an example embodiment may further include an interface capable of providing a user or an administrator with information.

Example embodiments of the present disclosure have been disclosed in the present specification and drawings. Although specific terms are used, these are only used in general meaning to easily explain the technical content of the present disclosure and to aid understanding of the present disclosure, but not intended to limit the scope of the present disclosure. It is obvious to those skilled in the art that other modified examples based on the technical idea of the present disclosure can be implemented in addition to the example embodiments disclosed herein.

The apparatus or terminal according to the above-described example embodiments may include a processor, a memory for storing and executing program data, a permanent storage such as a disk drive, a communication port for communicating with an external device, a user interface device such as a touch panel, a key, a button, or the like. Methods implemented as software modules or algorithms may be stored on a computer-readable recording medium as computer-readable codes or program instructions executable on the processor. Here, the computer-readable recording medium includes a magnetic storage medium (e.g., ROM (read-only memory), RAM (random-access memory), floppy disk, hard disk, etc.) and optical reading medium (e.g., CD-ROM and DVD (Digital Versatile Disc)). The computer-readable recording medium is distributed over networked computer systems, so that computer-readable codes can be stored and executed in a distributed manner. The medium is readable by a computer, stored in a memory, and executed on a processor.

The present example embodiment can be represented by functional block configurations and various processing steps. These functional blocks may be implemented with various numbers of hardware or/and software configurations that perform specific functions. For example, the example embodiment may employ an integrated circuit configuration such as memory, processing, logic, look-up table, or the like, capable of executing various functions by control of one or more microprocessors or other control devices. Similar to that components can be implemented with software programming or software elements, this example embodiment includes various algorithms implemented with a combination of data structures, processes, routines or other programming components and may be implemented with a programming or scripting language including C, C++, Java, assembler, Python, etc. Functional aspects can be implemented with an algorithm running on one or more processors. In addition, the present example embodiment may employ a conventional technique for at least one of electronic environment setting, signal processing, and data processing. Terms such as “mechanism”, “element”, “means”, and “composition” can be used in a broad sense, and are not limited to mechanical and physical configurations. Those terms may include the meaning of a series of software routines in connection with a processor or the like.

The above-described example embodiments are merely examples, and other example embodiments may be implemented within the scope of the claims to be described later.

It will be apparent to those skilled in the art that various modifications and variations can be made in the embodiments of the present invention without departing from the spirit or scope of the invention. Thus, it is intended that the present invention cover the modifications and variations of this invention provided they come within the scope of the appended claims and their equivalents.

What is claimed is:

1. An underwater acoustic signal detection method performed by an electronic apparatus, the method comprising:
identifying, based on acoustic data obtained from an acoustic signal received underwater, a target frequency value measured at a reference point in a time-frequency domain of the acoustic data;
determining whether the target frequency value is associated with tracking data related to tracking of a target detection acoustic signal included in the acoustic signal; and
updating the tracking data based on the association of the target frequency value with the tracking data,
wherein the tracking data comprise at least one tracking channel for tracking the target detection acoustic signal and at least one single tracking frequency value determined to be measured at a point in time prior to the reference point of the acoustic data.

2. The method of claim 1, wherein identifying a target frequency value comprises:
identifying the target frequency value based on a threshold value of a signal to noise ratio (SNR) of the frequency domain of the acoustic data at the reference point.

3. The method of claim 2, wherein the threshold value is determined for each individual frequency cell of a plurality of frequency cells included in the frequency domain.

4. The method of claim 3, wherein the threshold value is determined for each individual frequency cell based on signal-to-noise ratios of the individual frequency cell and a reference frequency cell corresponding to the individual frequency cell.

5. The method of claim 4, wherein the reference frequency cell comprises two or more frequency cells separated by different step-sizes relative to the individual frequency cell.

6. The method of claim 5, wherein the step-size is determined based on a frequency characteristic of the target detection acoustic signal.

7. The method of claim 1, wherein determining whether the target frequency value is associated with tracking data comprises:
determining whether the target frequency value is associated with the tracking data based on a statistical distance between the target frequency value and a predicted frequency value at the reference point determined in response to the tracking channel included in the tracking data.

8. The method of claim 1, wherein determining whether the target frequency value is associated with tracking data comprises:
identifying a tracking channel associated with the target frequency value from the tracking data; and
if no tracking channel associated with the target frequency value is identified, identifying a single tracking frequency value associated with the target frequency value from the tracking data.

9. The method of claim 8, wherein updating the tracking data comprises:
assigning the target frequency value to the tracking channel associated with the target frequency value.

10. The method of claim 8, wherein updating the tracking data comprises:
updating a status included in status information of the tracking channel associated with the target frequency value to a stabilized status.

11. The method of claim 8, wherein updating the tracking data comprises determining, based on each termination condition set for each tracking channel, whether to terminate a tracking channel with which the target frequency value is determined not to be associated from the tracking data, and
each termination condition is set based on status information of each tracking channel.

12. The method of claim 8, wherein updating the tracking data comprises:
creating a new tracking channel based on the target frequency value and the single tracking frequency value associated with the target frequency value.

13. The method of claim 1, wherein updating the tracking data comprises:
if the target frequency value is not associated with the tracking data, updating the tracking data to include the target frequency value as the single tracking frequency value in the tracking data.

14. The method of claim 1, wherein updating the tracking data comprises:
calculating a predicted frequency value at the reference point corresponding to the tracking data determined not to be associated with the target frequency value from the tracking data; and
including the calculated predicted frequency value as the tracking data.

15. A non-transitory computer-readable recording medium having a program for executing an underwater acoustic signal detection method recorded thereon, the underwater acoustic signal detection method comprising:
identifying, based on acoustic data obtained from an acoustic signal received underwater, a target frequency value measured at a reference point in a time-frequency domain of the acoustic data;
determining whether the target frequency value is associated with tracking data related to tracking of a target detection acoustic signal included in the acoustic signal; and
updating the tracking data based on the association of the target frequency value with the tracking data,
wherein the tracking data comprise at least one tracking channel for tracking the target detection acoustic signal and at least one single tracking frequency value determined to be measured at a point in time prior to the reference point of the acoustic data.

16. An electronic apparatus configured to perform an underwater acoustic signal detection method, the electronic apparatus comprising:
a transceiver;
a memory; and
a processor, wherein the processor is configured to control at least one of the transceivers and the memory to perform:
identifying, based on acoustic data obtained from an acoustic signal received underwater, a target frequency value measured at a reference point in a time-frequency domain of the acoustic data;
determining whether the target frequency value is associated with tracking data related to tracking of a target detection acoustic signal included in the acoustic signal; and
updating the tracking data based on the association of the target frequency value with the tracking data,
wherein the tracking data comprise at least one tracking channel for tracking the target detection acoustic signal and at least one single tracking frequency value determined to be measured at a point in time prior to the reference point of the acoustic data.
